(19) United States
(12) Patent Application Publication
(10) Pub. No.: US 2019/0350280 A1
(43) Pub. Date: Nov. 21, 2019

(54) CONTAINER OPENING DEVICE AND GARMENT

(71) Applicant: Abraham I. Allouche, Hallandale, FL (US)

(72) Inventor: Abraham I. Allouche, Hallandale, FL (US)

(21) Appl. No.: 16/293,096

(22) Filed: Mar. 5, 2019

Related U.S. Application Data
(63) Continuation-in-part of application No. 15/371,995, filed on Dec. 7, 2016, now abandoned.
Application No. 15/371,995 is a continuation-in-part of application No. 15/073,069, filed on Mar. 17, 2016, now Pat. No. 10,226,090.

(51) Int. Cl. A41D 27/20; A41D 1/089; B67B 7/16

(52) U.S. Cl. CPC A41D 27/201; B67B 7/16; A41D 1/089

(57) ABSTRACT

A garment structured to facilitate opening of a container, through the provision of an opening member mounted thereon. A garment includes a closure flap movable between a covering and a non-covering position, wherein the opening device includes a base and an opening member connected to said closure flap and movable therewith into an out of an exposed, operative orientation corresponding to the closure flap being disposed into and out of the covering relation to the pocket. When in the operative orientation, the opening member includes an apertured construction disposed and structured to engage and exert a removing force on a closure of the container, wherein the closure may be in the form of a cap on bottle or other container.

### CLAIM OF PRIORITY

The present application is a continuation-in-part application of previously filed, now pending U.S. patent application Ser. No. 15/371,995, filed on Dec. 7, 2016, which is a continuation-in-part application of previously filed, now pending U.S. patent application Ser. No. 15/073,069, filed on Mar. 17, 2016, incorporated herein by reference.

### BACKGROUND OF THE INVENTION

### Field of the Invention

The present invention is directed to garment having a container opening device mounted on and operable in combination with the garment, wherein an opening member is secured to a base which in turn is mounted on and movable with a flap structure, which may or may not be in the form of a closure flap for a pocket of the garment. The opening member and base are movable with the closure flap into and out of an exposed, operative orientation concurrently to the closure flap being disposed into and out of a closing position relative to the pocket.

### Description of the Related Art

Numerous individuals seek to bring capped containers, such as containers of juice, soda, or beer, to a wide-ranging possibility of events, for example to a concert or to the beach. As a result, such individuals frequently require some type of device in order to facilitate opening their capped containers. Known opening devices which are readily available on the commercial market include bottle openers and combination devices such as a bottle opener, can opener, and/or a corkscrew device. However, when an opening device is required to open a capped container, time and patience are needed to search and locate such a device. Additionally, an opening device is not convenient for individuals to transport with them due to its shape and size. Further, in many environments such as the beach, a picnic, etc. an opening device is frequently needed but frequently lost. Due to this inconvenience, most individuals do not transport an opening device with them.

Accordingly, there is a need for an opening device that is always ready and available, easily portable, and will not be lost while at an event. There appears to be an absence of a combined structure having multi-purpose uses such that an opening device may be utilized in combination with an item of everyday use, such as a garment. Despite the developments and advancements in opening devices, of the type set forth above, there is still a need for an improved opening device which can be combined with a garment that provides an easy way to remove a cap from the container. More specifically, a garment including an opening device mounted on a closure flap, which are concurrently positionable between open and closed positions and which will not derogatorily detract from the appearance of the garment or its comfort on an individual.

### SUMMARY OF THE INVENTION

The present invention is directed to garment having an opening device for removing a closure from a container. In more specific terms, the opening device may be mounted on and used in combination with a garment having a flexible material covering with at least two openings and structured to be worn by a user, such as, but not limited to, a pair of shorts, such as “boardshorts” of the type well known and used in the sport of surfing and in similar or related environments.

Accordingly, a detailed description of the structural and operative features of the present invention will be set forth in greater detail hereinafter with reference to a boardshort type of garment. However, it is emphasized that the opening device of the present invention can be mounted on and operable in combination with a variety of different types of garments and/or components of a garment in addition to and other than boardshorts, bathing suits or the like.

Therefore, one or more preferred embodiments of the present invention includes the referred to garment, which may or may not include a pocket and/or pouch and a closure flap. As such, the closure flap will be selectively disposable between a covering and non-covering position relative to an access opening of the pocket or pouch. However, a “flap structure” or similar type component may be mounted on or included with the overall structure of the garment. In such an embodiment, the garment may be absent a pocket or pouch, but include the flap structure, in order to maintain or enhance the overall design and/or appearance of the garment. Accordingly, when the flap structure is used without the presence or inclusion of a pocket or pouch, it may be disposed, dimensioned, and configured to substantially represent or appear as a closure flap. Therefore, as used herein the term “closure flap” is used to represent a flap structure which may or may not be operatively associated with a pocket or pouch as further described herein.

In cooperation therewith, the opening device includes a base which is connected to the closure flap and movable therewith between the covering and non-covering positions. In at least one embodiment, the base is secured to an under surface or inner surface of the closure flap. As such, when the closure flap is in the covering position, the base is not exposed and not clearly viewable. Further, the disposition of the base on the closure flap is such that the base and an opening member connected thereto are disposable between operative and non-operative orientations. When the closure flap is in the covering position the base and opening member will be disposed in the non-operative orientation and not clearly viewable. However, when intended for use, the closure flap will be moved to the non-covering position, relative to the access to the pocket. Accordingly, when the closure flap is in the non-covering position, the base and the opening member will be “exposed” and therefore be clearly viewable and accessible. Therefore, the base and the opening member will be in the aforementioned operative orientation.

In addition to the above, one or more preferred embodiments of the opening device include the opening member having an apertured construction. The apertured construction comprises at least one aperture which is cooperatively dimensioned and configured to at least partially receive the closure of the container therein. In addition, at least a portion of the closure member is preferably formed from a rigid, semi-rigid or at least partially rigid material to the extent that a force, sufficient to remove the closure, will be exerted on the closure of the container causing its removal. By way of example, the opening member or at least a portion thereof may be formed from a carbon fiber material which has sufficient rigidity and strength to exert the aforementioned removing force on the closure of the container.

Further by way of example, the dimension, configuration and disposition of the at least one aperture of the apertured construction, as well as the remaining parts of the opening member may be such as to remove a bottle cap from a bottle type container. However, the opening device and attendant opening member may be otherwise appropriately structured to accommodate the removal of other types of closures from other types of containers.

Yet additional structural and operative features of one or more embodiments of the opening device include the base having at least one opening disposed in aligned relation with the at least one aperture in the opening member. Accordingly, the aforementioned “apertured construction” can also be descriptive of both the at least one aperture in the opening member and the at least one opening in the base, being disposed in aligned relation with one another. As will also be described in greater detail hereinafter, utilization of the opening device to remove a bottle cap or other type closure from a corresponding container involves the closure being disposed at least partially within the one aperture of the opening member concurrently to being at least partially received within the aligned one opening of the base. When so disposed, the at least partial rigidity of the opening member and the manipulation of the container closure relative to the base (or vice versa) will result in a removing force being exerted on the closure or bottle cap.

Yet additional features of the opening device include a cover connected to the base in covering or closing relation to the one aperture of the opening member as well as the aligned one opening of the base. Also, the disposition of the cover is such as to at least partially engage and/or receive the closure of the container as it enters through the one aperture of the opening member and the one opening of the base. Such a disposition of the cover will at least partially limit the passage of the closure concurrently through the aperture and opening respectively of the opening member and base. As such, the closure or bottle cap will be prevented from passing completely through the closure flap to which the base is attached. Therefore, in at least one embodiment, the cover is disposed on the opposite side of the base relative to the opening member, while still being disposed in closing or covering relation to both the aperture and opening.

In order to facilitate mounting and/or attachment of the opening device to the garment in a manner, which will not derogatorily affect the appearance of the garment or its comfort on a wearer, the base and the cover are preferably formed of a flexible, relatively high strength material. Such material can include, but is not intended to be limited to, a canvas or other appropriate material of sufficient strength or flexibility. This of course is in contrast to the appropriate rigidity of the opening member, as set forth above.

Yet additional features of one or more embodiments of the combination opening device and garment include an attachment structure at least partially mounted on the base and a correspondingly disposed part of the garment. Moreover, the attachment structure can be operable to removably retain the closure flap in the covering position relative to the access opening of the pocket or pouch. However once intended for use, the attachment structure may be easily disconnected from the garment thereby facilitating the disposition of the closure flap into the non-covering position concurrently to the base and opening member being disposed in the exposed, operative orientation.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side elevational view of a garment including an opening device mounted thereon.

FIG. 2 is a side elevational view of the embodiment of FIG. 1, wherein the opening device is in an exposed, operative orientation.

FIG. 3 is a detail view of structural and operative components of the present invention in an exploded form.

FIG. 4 is a detail view of the opening device including the structural and operative components thereof.

FIG. 5 is an at least partially exploded view of details of the opening device of FIGS. 1-4 and a closure flap of the garment, as represented in FIGS. 1 and 2.

FIG. 6A is a detail view of structural and operative components of another embodiment of the present invention in an exploded form.

FIG. 6B is a top view of structural and operative components of embodiment in FIG. 6A in an exploded form.

Like reference numerals refer to like parts throughout the several views of the drawings.

### DETAILED DESCRIPTION OF THE PREFERRED EMBODIMENT

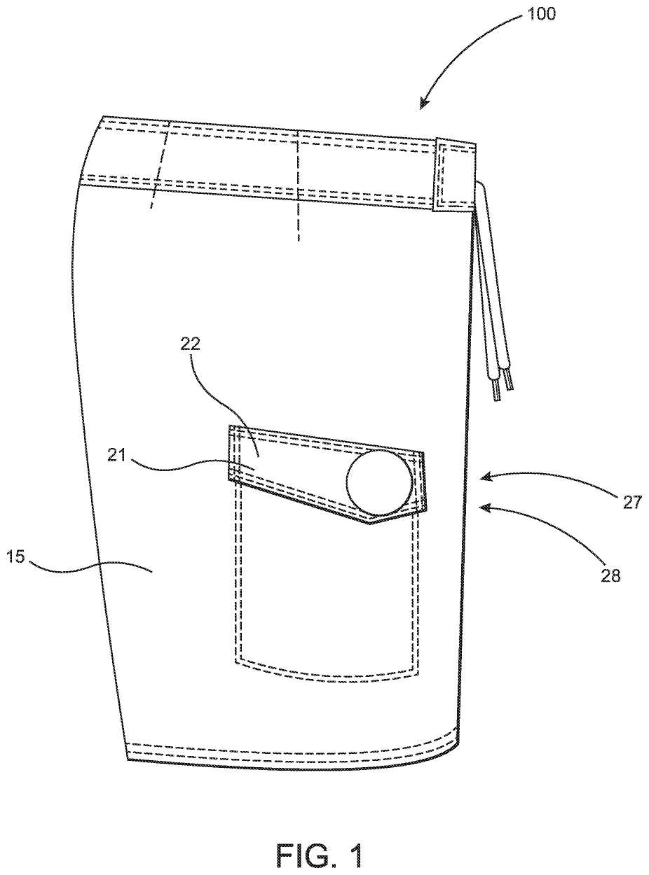

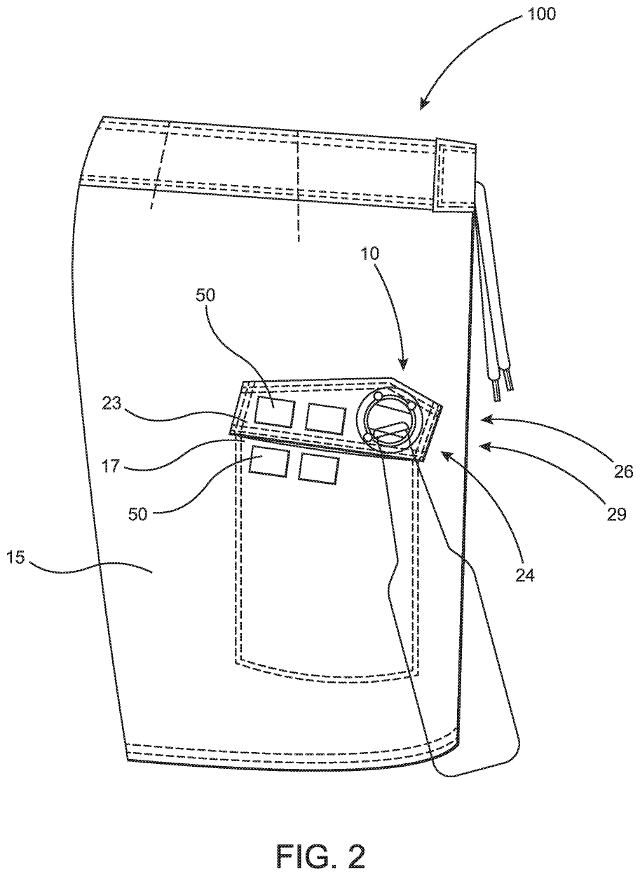

As represented in the accompanying Figures and with initial reference to FIGS. 1 and 2, at least one preferred embodiment of the present invention is directed to a garment 100 having an opening device generally indicated as 10. The opening device 10 includes sufficient structural and operative versatility to facilitate its use while mounted on and used in combination with the garment 100. The garment 100 preferably includes a flexible material covering 15 with at least two openings, and structured to be worn by a user, such as, but not limited to, a pair of shorts, such as “boardshorts” or bathing suits. Accordingly, for purposes of clarity and without limiting the scope of the present invention, the structural features of this invention will be described with reference to a garment 100 being in the form of boardshorts, bathing suits, etc. of the type represented in FIGS. 1 and 2. However, it is emphasized that the opening device 10 of the present invention can be mounted on and operable in combination with a variety of different types of garments 100 and/or components of a garment 100 in addition to and other than boardshorts, bathing suits or the like. Furthermore, the flexible material covering 15 includes at least one pocket with an access opening to allow access to an interior of the pocket, and a closure flap 22 structured to open and close by moving between an open and closed orientation in order to regulate access to the pocket.

As represented in FIGS. 1 and 2, one or more preferred embodiments of the present invention include the referred to-opening device 10, which may include at least one “flap structure”. The flap structure is preferably disposed, dimensioned and configured in the form of the closure flap 22. As such, the closure flap 22 is selectively disposable between a covering position 27 and non-covering position 29 relative to an access opening of a pocket or pouch on a garment and/or an opening member 30 as set forth in greater detail hereinafter. Of course, it is understood that the opening device 10 may be mounted directly to a primary surface or pocket of the flexible material garment 15 independent of the closure flap 22.

However, in order to maintain and/or enhance the appearance of a garment 100, even in the absence of an operative pocket or pouch thereon, the “flap structure” may still be disposed, dimensioned and configured to represent a closure flap 22. Accordingly, when a garment 100 does not include a pocket or pouch, the closure flap 22 is still selectively positioned between the “covering position” 27 and the “non-covering position” 29 relative to the opening member 30.

Further, the “flap structure” may or may not be removably connected to a garment. This removable connection may be accomplished by an appropriate adhesive material or other sufficiently strong connecting structures to maintain the connection of the “flap structure” to a garment. Accordingly, such connecting structures may include one or more adhesive type connectors or similarly structured connectors such as Velcro which allows a secure but removable positioning of the “flap structure” on a garment, but also allows for its removal from a garment when so chosen by the user. In contrast, such connecting structures may also include one or more static type connectors such as stitches or rivets which allow the fixed positioning of the “flap structure” on a garment.

The closure flap 22 may include an exterior or outer surface 21 and an interior or inner surface 24 and movable therewith between the covering position 27 and the non-covering position 29 relative to an access opening of a pocket or pouch and/or the opening member 30. As such, when the closure flap 22 is in the covering position 27, the inner surface 24 is not exposed and not clearly viewable. In contrast, when the closure flap 22 is in the non-covering position 29, the inner surface 24 is exposed, accessible and clearly viewable. Further, and as set forth in greater detail hereinafter, when the closure flap 22 is in the non-covering position 29, the opening member 30 will be in an operative orientation 26 and ready for use. In contrast, when the closure flap 22 is in the covering position 27, the opening member 30 will be in a non-operative orientation 28.

In at least one embodiment, the opening member 30 may be directly connected to the inner surface 24 of the closure flap 22, such that the disposition of the inner surface 24 on the closure flap 22 is such that the inner surface 24 is disposable between the operative orientation 26 and the non-operative orientation 28. More specifically, when the closure flap 22 is in the covering position 27, the inner surface 24 will be disposed in the non-operative orientation 28 and not clearly viewable, as represented in FIG. 1. However, when the opening device 10 is intended for use, the closure flap 22 will be moved to the non-covering position 29. Accordingly, when the closure flap 22 is in the non-covering position 29, the inner surface 24 will be exposed and therefore be clearly viewable and accessible to the user. Therefore the inner surface 24 and the opening member 30 connected thereto will be in the aforementioned operative orientation 26, as represented in FIG. 2.

As such, when the closure flap 22 is in the covering position 27, the inner surface 24 is not exposed and not clearly viewable. Further, the disposition of the inner surface 24 on the closure flap 22 is such that the inner surface 24 and an opening member 30 connected thereto are disposable between the operative orientation 26 and the non-operative orientation 28. When the exterior or outer surface 21 of the closure flap 22 is viewable and the closure flap 22 is in the covering position, the inner surface 24 and opening member 30 will be disposed in the non-operative orientation 28 and not be clearly viewable, as represented in FIG. 1. However, when the opening device 10 is intended for use, the inner surface 24 will be moved to the operative orientation 26 and the closure flap 22 will be disposed in the non-covering position 29. Accordingly, the inner surface 24 and the opening member 30 will be exposed and therefore be clearly viewable and accessible to the user. As such, the inner surface 24 and the opening member 30 will be in the aforementioned operative orientation 26, as represented in FIG. 2.

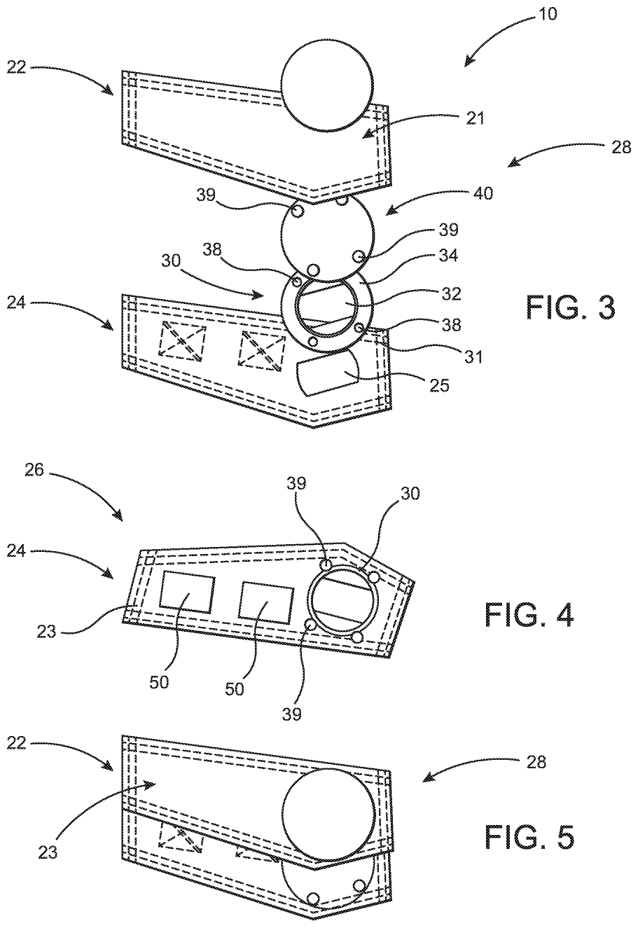

As is represented in FIGS. 1, 2, 4, and 5, the closure flap 22 may in fact be an integrated part of the inner surface 24. However, the closure flap 22 and the inner surface 24 in fact may be different structures, wherein the closure flap 22 overlies the inner surface 24 when the inner surface 24 is in the non-operative orientation 28, as is represented in FIG. 3.

As represented in FIG. 3, the opening device 10 includes the referred to opening member 30, structured and disposed to remove the closure from the container. As described above, the opening member 30 may be connected to the inner surface 24 of the closure flap 22 and movable therewith between the operative orientation 26 and the non-operative orientation 28. One preferred embodiment of the opening device 10 includes the opening member 30 having an apertured construction 32. The apertured construction 32 comprises at least one aperture 34 which is cooperatively dimensioned and configured to at least partially receive the closure of the container therein.

In addition, at least a portion of the opening member 30 is preferably formed from at least a partially rigid material to the extent that a force, sufficient to remove the closure, will be exerted on the closure causing its removal. By way of example, the opening member 30, or at least a portion thereof, may be formed from a carbon fiber material which has sufficient rigidity and strength to exert the aforementioned removing force. Further, by way of example, the dimension, configuration, and disposition of the one aperture 34 may be such as to remove a bottle cap from a bottle type container. However, the opening device 10 and attendant opening member 30 may be otherwise appropriately structured to accommodate the removal of other types of closures from other types of containers.

In addition, the opening member 30 may include at least one orifice 38 disposed and structured to secure the opening member 30 to the inner surface 24 of the closure flap 22. More specifically, the disposition of the opening member 30 may be secured between the closure flap 22 and the inner surface 24, as represented in FIG. 3. However, in another embodiment, the opening member 30 may be secured to the inner surface 24, as represented in FIG. 4. As such, when the opening member 30 is disposed on the inner surface 24, the opening member 30 may be secured by at least one connector 39. Accordingly, the at least one connector 39 is disposed in secured aligning relation with the at least one orifice 38 of the opening member 30. However, in another embodiment, when the opening member 30 is disposed on the inner surface, the opening member 30 may be secured by connectors such as stitches or rivets.

Additionally, when the closure flap 22 is in the covering position 27, the inner surface 24 and the one aperture 34 of the opening member 30 are not exposed and not clearly viewable. Further, the disposition of the inner surface 24 on the closure flap 22 is such that the inner surface 24 and the one aperture 34 of the opening member 30 connected thereto are disposable between the operative 26 and non-operative orientation 28. More specifically, when the closure flap 22 is in the covering position 27, the inner surface 24 and one aperture 34 of the opening member 30 will be disposed in the non-operative orientation 28 and not clearly viewable, as represented in FIG. 1. However, when the opening device 10 is intended for use, the closure flap 22 will be moved to the non-covering position 29 relative to an access opening of a pocket and/or the opening member 30. Accordingly, when the closure flap 22 is in the non-covering position 29, the inner surface 24 and the one aperture 34 of the opening member 30 will be exposed and therefore be clearly viewable and accessible to the user. Therefore the inner surface 24 and the one aperture 34 of the opening member 30 will be in the aforementioned operative orientation 26, as represented in FIG. 2. As such, the user can utilize the opening device 10 to remove the closure from the container.

Further, when the opening member 30 is secured between the inner surface 24 and closure flap 22, as is represented in FIG. 3, the one aperture 34 of the opening member 30 will be clearly viewable when the inner surface 24 is in operative orientation 26. In contrast, when the opening member 30 is secured to the inner surface 24, as is represented in FIG. 4, the entire opening member 30 will be clearly viewable. Accordingly, the at least one connector 39, disposed in aligned relation with the at least one orifice 38, may also be clearly viewable.

In addition, the opening member 30 may include at least one protruding lip 31. The protruding lip 31 is structured to exert a force on the closure while concurrently creating space between the closure and a garment. Utilization of the opening member 30 to remove the closure involves the closure being disposed at least partially within the one aperture 34 of the opening member 30. The space created allows for the closure to be removed without the closure engaging forcefully with the fabric of a garment. The protruding lip 31 extends outward from the opening member 30 a distance sufficient to create the aforementioned space in order to protect a garment from the force exerted to remove the closure.

Yet additional structural and operative features of one or more embodiments of the opening device 10 may include the inner surface 24 having at least one opening 25 disposed in aligned relation with the one aperture 34 of the opening member 30. Accordingly, the aforementioned apertured construction 32 can also be descriptive of both the one aperture 34 and the one opening 25, being disposed in aligned relation with one another. As such, the opening member 30 may be disposed between the closure flap 22 and inner surface 24. Utilization of the opening device 10 to remove a closure involves the closure being disposed at least partially within the one aperture 34 concurrently to being at least partially received within the aligned one opening 25. When so disposed, the at least partial rigidity of the opening member 30 and the manipulation of the closure relative to the inner surface 24 (or vice versa) will result in a removing force being exerted on the closure or bottle cap.

As represented in FIG. 3, yet additional features of the opening device 10 include a cover member 40 connected to the inner surface 24. The cover member 40 may be disposed in covering or closing relation to at least a portion of the opening member 30 as well as the aligned one opening 25 of the inner surface 24. However, as discussed above, when the opening member 30 is disposed on the inner surface 24, the cover member 40 may be in covering or closing relation to only the one aperture 34 of the opening member 30. Additionally, the disposition of the cover member 40 is such as to at least partially engage and/or receive the closure as it enters through the one aperture 34 and the one opening 25. Such a disposition of the cover member 40 will at least partially limit the passage of the closure concurrently through the one aperture 34 and the one opening 25 respectively of the opening member 30 and inner surface 24. As such, the closure or bottle cap will be prevented from passing completely through the closure flap 22 to which the inner surface 24 is attached. By way of example, the cover member 40, or at least a portion thereof, may be formed from a material which has sufficient strength, such as canvas or the like. Further, in at least one embodiment, the cover member 40 is disposed on the opposite side of the inner surface 24 relative to the opening member 30, while still being disposed in closing or covering relation to both the one aperture 34 and the one opening 25.

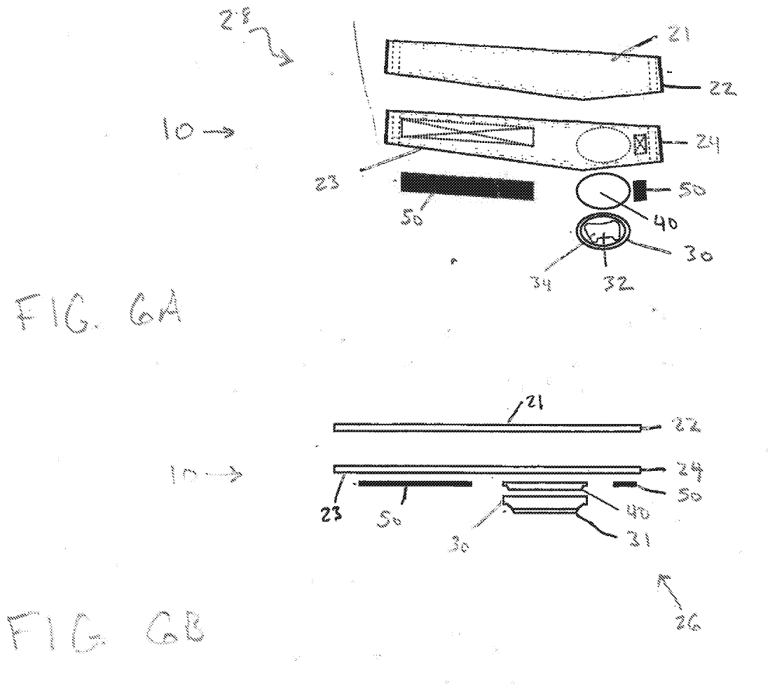

As represented in FIGS. 6A-6B, yet another preferred embodiment includes both the opening member 30 and connected cover member 40, which may be mounted to the inner surface of the closure flap 22 or directly to the garment. More specifically, the inner surface 24 may be connected to the closure flap 22 in such a manner that the inner surface 24 and the closure flap 22 may be considered an integrated construction. Alternatively, the inner surface 24 may be defined by the closure flap 22, such that the term inner surface and closure flap may be used interchangeably. Moreover, in the embodiment of FIGS. 6A-6B the opening member 30 may be considered a substantially structural equivalent to the opening member 30 as disclosed and described with primary reference to FIG. 3. As such, the opening member 30 may be at least partially rigid and include, but not be limited to, the apertured construction 32 including the at least one aperture 34 structured to have a lip 31. Accordingly, upon at least partial insertion of a closure of a container within the aperture 34, a removal force may be exerted thereon upon a proper manipulation of the container, relative to the opening member 30, resulting in removal of the closure or from the container.

As mentioned, when the opening member 30 and the cover member 40 are directly connected to the garment, the closure flap 22 is selectively disposable between a covering position 27 and non-covering position 29 relative to the opening member 30 and the cover member 40. Further, the opening member 30 and the cover member 40 may be secured to the inner surface 24 of the closure flap 22, such that the inner surface 24 is disposable between the operative orientation 26 and the non-operative orientation 28.

More specifically, the cover member 40 may be secured between the inner surface 24 and the opening member 30. As such, the cover member 40 may be disposed in interconnecting relation between the opening member 30 and the inner surface 24. Accordingly, the cover member 40 may be disposed in covering or closing relation to an inner or underside of the entire opening member 30. As such, the opening member 30 may be clearly viewable when in the operative orientation 26. This disposition of the cover member 40 may be such as to at least partially engage and/or receive the closure as it enters through the one aperture 34 of the opening member 30. Such a disposition of the cover member 40 will at least partially limit the passage of the closure through the one aperture 34 of the opening member 30. As such, the closure or bottle cap will be prevented from passing through the cover member 40 to the inner surface 24, to which the cover member 40 is attached.

Further, the cover member 40 and interconnected opening member 30 may or may not be removably connected to the inner surface 24 or garment. This removable connection may be accomplished by an appropriate adhesive material or other sufficiently strong connecting structures to maintain the connection. Such connecting structures may include adhesive type connectors, such as Velcro, which allows a secure but removable positioning of the cover member 40 to the inner surface 24 or garment, but also allows for its removal when so chosen by the user. In contrast, such connecting structures may also include static type connectors, such as stitches, which allow the fixed positioning of the cover member 40 to the inner surface 24 or garment. In another embodiment, similar as described above, the opening member 30 may or may not be removably connected to the cover member 40.

However, it is emphasized that the opening member 30, or the opening member 30 and cover member 40, may be directly connected to the garment itself without the use of a “flap structure” 22. This may serve to position the opening member 30 in the operative orientation 26 perpetually. In another embodiment, the opening member 30, or the opening member 30 and cover member 40, may be directly connected to the garment disposable between an operative orientation 26 and a non-operative orientation 28 by the closure flap 22.

In order to facilitate the mounting and/or attachment of the opening device 10 to a garment in a manner which will not derogatorily affect the appearance of a garment or its comfort on a user, the inner surface 24 and the closure flap 22 are preferably formed of a flexible, relatively high strength material. Such material can include, but is not intended to be limited to, a canvas or other appropriate material of sufficient strength or flexibility. This of course is in contrast to the appropriate rigidity of at least a portion of the opening member 30, as set forth above.

However, while the placement of the opening device 10 on the outside of a garment may be the most popular placement of use, the opening device 10 may also be placed on the inside of a garment or connected via attachment to a garment. Additionally, when the closure flap 22 is selectively disposable between the covering position 27 and non-covering position 29 relative to the opening member 30, a pocket of a garment is not necessary to the invention, as discussed above. Further, there may be more than one opening device 10 mounted on a garment, the opening device 10 may comprise different shapes/sizes, and be placed in different positions relative to the outside and/or inside of a garment.

As represented in FIGS. 3, 6A and 6B, yet another additional feature of the preferred embodiment of the opening device 10 includes an attachment structure 50. The attachment structure 50 is at least partially mounted on the inner surface 24 and a correspondingly disposed part of a garment. Moreover, the attachment structure 50 can be operable to removably retain the inner surface 24, in the non-operative orientation 28, to a garment. However, once intended for use, the attachment structure 50 may be easily disconnected from a garment thereby facilitating the disposition of the inner surface 24 into the operative orientation 26 concurrently to the inner surface 24 and the opening member 30 being disposed in the exposed, operative orientation 26.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A garment structured to open a container, said garment comprising:
a flexible material covering having at least two openings and structured to be worn by a user;
said flexible material covering including at least one pocket and at least one closure flap structured to open and close to regulate access to said pocket;
an opening member connected to said flexible material covering and disposable thereon in an operative orientation;
said opening member having an apertured construction disposed and structured to remove a closure from the container, at least when said opening member is in said operative orientation;
said apertured construction comprising at least one aperture dimensioned to at least partially receive the closure therein and structured to exert a removing force thereon; and
said closure flap structured to conceal said opening member when closed and to define said operative orientation of said opening member when open.

2. The garment as recited in claim 1 further comprising a cover member connected to said flexible material covering and disposed in covering relation to at least a portion of said opening member and at least a portion of the closure, when the closure is received within said opening member.

3. The garment as recited in claim 2 wherein said cover member is disposed in interconnecting relation between said flexible material covering and at least a portion of said opening member.

4. The garment as recited in claim 1 wherein said flexible material covering defines a pair of shorts.

5. The garment as recited in claim 2 wherein said opening member and said cover member are connected to said closure flap and movable therewith, at least between said open and closed orientation of said closure flap.

6. The garment as recited in claim 5 wherein said opening member and said cover member are disposed on an inner surface of said closure flap.

7. The garment as recited in claim 5 wherein said closed orientation of said closure flap substantially corresponds to a covering orientation relative to said opening member.

8. The garment as recited in claim 5 wherein said closed orientation of said closure flap substantially corresponds to a non-operative orientation of said opening member.

9. The garment device as recited in claim 1 further comprising an attachment structure connected to said inner surface of said closure flap and structured to removably connect and retain said closure flap in said closed orientation.

10. The garment as recited in claim 9 wherein said opening member is connected to an inner surface of said closure flap and movable therewith, at least between said open and closed orientation of said closure flap.

11. The garment recited in claim 1 wherein said pocket includes an access opening, said opening member attached to said closure flap and movable with said closure flap into covering and non-covering relation to said access opening of said pocket.
